(19) United States
(12) Patent Application Publication
(10) Pub. No.: US 2009/0099291 A1
(43) Pub. Date: Apr. 16, 2009

(54) ORGANOSILICON-POLYUREA BASE POLYMER, ELASTOMER PREPARED THEREFROM, PREPARATION THEREOF AND USE OF THE SAME

(75) Inventors: Xudong Jia, Nanjing (CN); Kai Xi, Nanjing (CN); Renjie Ge, Nanjing (CN); Xuehai Yu, Nanjing (CN)

Correspondence Address: HENKEL CORPORATION, 1001 TROUT BROOK CROSSING, ROCKY HILL, CT, 06067, US

(73) Assignee: Henkel AG & Co KGaA, Duesseldorf (DE)

(21) Appl. No.: 12/254,635

(22) Filed: Oct. 20, 2008

Related U.S. Application Data
(63) Continuation of application No. PCT/EP2007/053724, filed on Apr. 17, 2007.

(30) Foreign Application Priority Data
Apr. 18, 2006 (CN) 200610077021.9
Apr. 26, 2006 (CN) 200610077100.X

(51) Int. Cl. C08G 77/18; C08K 3/22; C08K 3/26; C08K 3/04; C08K 3/36

(52) U.S. Cl. 524/425; 528/28; 524/431

(57) ABSTRACT

An organosilicon-polyurea base polymer capable of self-crosslinking under humid condition, an elastomer prepared therefrom, preparation thereof and use of the same. By using an amino-polysiloxane, a polyisocyanate, and multiple active amino-containing silane as main materials, an organosilicon-polyurea base polymer is prepared by virtue of the copolymerization thereof. The organosilicon-polyurea base polymer has excellent high- and low-temperature resistance, and solvent resistance, and relatively better mechanical properties, and is also curable at room temperature. A crosslinked network structure of intra- and inter-molecules is formed in the base polymer through inter-crosslinking of siloxane groups at terminals and side chains of the molecular chains, thereby producing adhesives, sealants, coatings and buffer layers, in particular sealants used in automotive industry.

### TECHNICAL FIELD

The present invention relates to self-crosslinking organosilicon-polyurea base polymer, elastomer prepared therefrom, preparation thereof and use of the same. The elastomer prepared from the base polymer can be widely used in the fields of adhesives, sealants, gaskets, buffer layers and coatings, in particular used for sealants in the automobile industry.

### BACKGROUND TECHNOLOGY

With the continued development of the modern automobile industry, requirements for high-performance functional materials have become ever more rigorous. For example, sealants used for automobile parts, such as oil pipes and hoods, not only should have good sealing properties, but also should be high- and low-temperature resistant, solvent resistant, stretchable, and curable at room temperature. And the requirements on volatile organic content of such materials used as sealants have become more rigorous and complex due to the regulations that need to be considered when various countries pay increasingly more attention to environmental protection. Although many organizations are studying high-performance self-crosslinking sealant materials at present, the need continues to exist for such sealant materials and most methods for preparation thereof are very complicated.

There are many reports about the use of polyurethane and polyurea materials as sealants and adhesives, for instance, (1) R. H. Baney, M. Itoh, A. Sakakibara, and T; Suzuki, Chem. Rev., 95:1409 (1995); (2) Zhang, T, Xi, K. Chen, H, et al. J APPL POLYM SCI 91(1): 190-195 Jan. 5, 2004; and (3) X. H. Yu, M. R. Nagarajan, T. G. Grasel, P. E. Gibson, and S. L. Cooper, J. Polym. Sci.: Polym. Phys. Ed., 23.2319. However, those materials that use polyethers as soft segments do not have satisfactory high- and low-temperature resistance, and are easily deformed by swelling in organic solvent. Although silane coupling agents have been used in room temperature curable materials, due to its too high strength after crosslinking, the resulting material has little elasticity, and is easily ruptured and broken off. As for epoxy resins, they do not have enough high- and low-temperature resistance to be suitable for use in automobile assembly applications. And polyimides, while having many beneficial physical properties, are viewed by the industry as simply being too expensive to be of practical benefit.

Methods for synthesizing polysiloxanelpolyurea block copolymers have been reported, for example, (1) U.S. Pat. No. 6,407,195; and (2) Siloxane-Urea Segmented Copolymers, 1. Yilgor, J. E. McGrath, Polymer Bulletin 8, 535-550, 1982. However, the block polymers obtained in these reported activities have only terminal crosslinking groups, which restrict their ability to crosslink in forming polymeric structure.

### SUMMARY OF THE INVENTION

The present invention provides an organosilicon-polyurea base polymer capable of self-crosslinking under humid conditions, which may be in the form of sol with organic solvent and which is curable at room temperature (about 25° C.).

The present invention also provides an elastomer obtained by crosslinking the organosilicon-polyurea base polymer, which satisfies the requirements in practical use with respect to high- and low-temperature resistance, solvent resistance and tensile properties.

The present invention also provides a simple and easily-operated method for the preparation of the organosilicon-polyurea base polymer.

The present invention also provides the use of the organosilicon-polyurea base polymer and the elastomer prepared therefrom in the fields of adhesives, sealants, gaskets, buffer layers and coatings.

The term “self-crosslinking” used herein refers to that the polymer involved is able to crosslink in the presence of environmental humidity, without adding an additional crosslinking agent.

The term “base polymer” used herein refers to the polymer that can be subjected to further crosslinking, thereby forming a polymeric final product.

The term “elastic” used herein refers to that the polymer involved can correspondingly deform (be sheared, compressed or elongated) under the action of an outside force, and can rapidly resume almost original length or shape after removing the outside force.

The term “reactive components for forming the base polymer” refers to all reactive substances taking part in the preparation of the organosilicon-polyurea base polymer, with catalyst component included (if any).

The organosilicon-polyurea base polymer provided herein is characterized by the following formula:

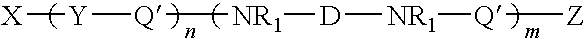

where:

m, n are respectively an integer from 1 to 750;

Q′=CO—NR-Q-NR—CO, where: Q is a divalent moiety selected from C₆-C₂₀ arylene radical, C₆-C₂₀ aralkylene radical, C₁-C₂₀ alkylene radical, C₆-C₂₀ cycloalkylene, and combinations thereof; and R is hydrogen or C₁-C₁₂ alkyl radical;

R₁ is selected from hydrogen, C₁-C₁₂ alkyl radical, C₁-C₂₀ cycloalkyl radical, C₆-C₂₀ aryl radical, C₆-C₂₀ aralkyl radical, C₆-C₂₀ alkaryl radical and combinations thereof;

Y is embraced by the structure:

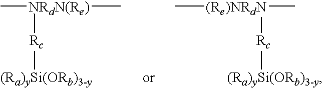

where: Rₐ, and R_{b} are respectively selected from C₁-C₁₆ alkyl radical, C₆-C₂₀ aryl radical, C₆-C₂₀ aralkyl radical, C₆-C₂₀ alkaryl radical, and combinations thereof: y=0 to 3; Rₐ is a divalent moiety selected from C₁-C₁₂ alkylene radical, C₁-C₁₂ imino-containing alkylene radical, C₆-C₂₀ imino-containing arylene radical, C₆-C₂₀ aralkylene radical, C₆-C₂₀ alkarylene radical, and combinations thereof;

R_{d} is a direct bond, or a divalent moiety selected from C₁-C₁₂ alkylene radical, C₁-C₁₂ imino-containing alkylene radical, C₈-C₂₀ imino-containing arylene radical, C₆-C₂₀ aralkylene radical, C₆-C₂₀ alkarylene radical, and combinations thereof, and

Rₑ is selected from hydrogen, C₁-C₁₂ alkyl radical, C₁-C₁₂ imino-containing alkyl radical, C₆-C₂₀ imino-containing aryl radical, C₆-C₂₀ aralkyl radical, C₆-C₂₀ alkaryl radical, and combinations thereof;

D is embraced by the structure:

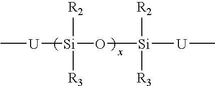

where: x ranges from 1 to 2000;

U is a divalent moiety selected from C₁-C₁₂ alkylene radical, C₁-C₁₂ iminoalkyl or polyiminoalkyl radical, C₆-C₂₀ cycloalkylene radical, C₆-C₂₀ iminocycloalkyl radical, C₆-C₂₀ arylene or aryleneamino radical, C₆-C₂₀ aralkylene radical, C₆-C₂₀ alkarylene or iminoaryl radical, and combinations thereof; and

R₂ and R₃ are respectively selected from C₁-C₁₂ alkyl radical, C₆-C₂₀ cycloalkyl radical, C₆-C₂₀ aryl radical, C₆-C₂₀ aralkyl radical, C₁-C₁₆ alkaryl radical and combinations thereof;

X is selected from H, OCN-Q-NRCO—, HNR₁-D-NR₁-Q′-, and E-Q′-, where R, D, R₁, Q and Q′ are defined as above;

Z is selected from —Y—X, —NR₁-D-NR₁—X, and E, where Y, X, R₁ and D are defined as above;

where the above E is a residue of monoamine monomer or a residue of monoimino silane end-capping agent, with the residue of monoamine monomer having a general formula: —N(Rₑ)R_{f}, and the residue of monoimino silane end-capping agent having a general formula: —N(Rₑ)—R_{g}—Si(Rₑ)_{y}(OR_{b})_{3-y}, where Rₑ, Rₐ, R_{b} and y are defined as above; R_{f} is selected from alkyl radical, C₆-C₂₀ cycloalkyl radical, C₈-C₂₀ aryl radical, C₆-C₂₀ aralkyl radical, alkaryl radical, and combinations thereof, R_{g} is a divalent moiety selected from alkylene radical, C₆-C₂₀ cycloalkylene radical, C₆-C₂₀ arylene radical, C₆-C₂₀ aralkylene radical, C₆-C₂₀ alkarylene radical, and combinations thereof.

Q in the above formula is preferably selected from tolylene radical, 4,4′-diphenylenemethyl radical, 3,3′-dimethyl-4,4′-biphenylene radical, tetramethyl-m-dimethylenephenyl radical, phenylene radical, naphthylene radical, 4,4′-dicyclohexylenemethyl radical, 1,6-hexylene radical, 1,4-cyclohexylene radical, methylcyclohexylene radical and 3,5,5-trimethyl-3-methylenecyclohexyl radical.

The base polymer described herein has a weight average molecular weight of preferably from 3×10² to 2×10⁵, more preferably from 2×10³ to 1.5×10⁵, and a molecular weight distribution index of preferably from 1 to 3. The molecular weight and molecular weight distribution described herein are determined by gel permeation chromatography, with polystyrene as the test standard.

In one embodiment of the present invention, the reactive components for preparing the organosilicon-polyurea base polymer comprise:

(A) a polyisocyanate having two or more isocyanate functional groups;

(B) a polysiloxane having two amino or imino groups; and

(C) a silane having two or more amino, imino, hydrazino, and/or alkylhydrazino and from 0 to 3 alkoxy groups.

In another embodiment of the present invention, the reactive components further comprise an end-capping agent selected from monoamino silanes and monoamines, and/or an auxiliary chain extender selected from diamines or polyamino compounds, which may be added at any step (either step (1) or step (2)) of polymerizing the base polymer. When a monoamine end-capping agent monomer is added, X in formula of the base polymer is chosen as E-Q′, and Z in formula of the base polymer is chosen as E.

The suitable polyisocyanate component A used herein includes polyisocyanates having two or more isocyanate groups, preferably polyisocyanates having an average functionality of 2 to 4, most preferably polyisocyanates having an average functionality of 2. The amount of the polyisocyanates, based on the total weight of reactive components for preparing the base polymer, is 0.1 to 60% by weight, preferably 2 to 50% by weight, more preferably 5 to 35% by weight. The polyisocyanates include aliphatic, alicyclic, aliphatic-aromatic or aromatic polyisocyanates. The polyisocyanates are preferably selected from the following monomers, oligomers thereof, derivatives thereof and mixtures thereof, said monomers include, but are not limited to: diphenylmethane diisocyanate, isophorone diisocyanate (IPDI), hexamethylene diisocyanate, dicyclohexylmethane diisocyanate, naphthalene diisocyanate, p-phenylene diisocyanate, cyclohexylene diisocyanate, xylylene diisocyanate, totramethyl-m-xylylene diisocyanate, 2,5(2,6)-di(isocyanatomethyl)-bicyclo[2,2,1]heptane, norbornane diisocyanate, 4,4′-methylene-bis-phenyl-diisocyanate (MDI), tolylene diisocyanate (TDI), 1,6-hexamethylene diisocyanate (HDI), tetramethyl-phenyldimethylene diisocyanate (TMXDI), triphenylmethane diisocyanate, methylcyclohexyl diisocyanate, triisocyanates, and tetraisocyanates, and polymethylenepolyphenyl polyisocyanates. The preferred one is MDI, TDI, HDI, IPDI or mixtures thereof in any ratio.

The polysiloxane component B used herein includes polysiloxanes having two amino or imino groups embraced by the structure:

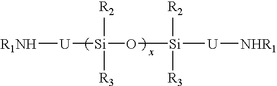

where x and U are defined as above;

R₁ is selected hydrogen, C₁-C₁₂ alkyl radical, C₆-C₂₀ cycloalkyl radical, C₆-C₂₀ aryl radical, C₆-C₂₀ aralkyl radical, C₆-C₂₀ alkaryl radical and combinations thereof; and

R₂ and R₃ are respectively selected from C₁-C₁₂ alkyl radical, C₆-C₂₀ cycloalkyl radical, C₆-C₂₀ aryl radical, C₆-C₂₀ aralkyl radical, C₆-C₂₀ alkaryl radical, and combinations thereof.

The polysiloxane component B used herein has a weight average molecular weight of preferably from 1.92×10² to 1.0×10⁵, and a molecular weight distribution index of preferably from 1 to 3. The amount of the polysiloxane component B, based on the total weight of reactive components for preparing the base polymer, is 30 to 99.9% by weight.

Aminohydrocarbyl polysiloxane is preferred as component B herein, and is selected from aminopropyl dimethyl terminated polydimethylsiloxane, cyclohexylaminopropyl dimethyl terminated polymethylphenylsiloxane, aminomethyl dimethyl terminated polydimethylsiloxane, aminopropyl dimethoxyl terminated polydimethylsiloxane, aminomethyl diethoxy terminated polydimethylsiloxane, aminomethyl vinylmethoxy terminated polydimethylsiloxane, ethyl aminopropyl methylethoxy terminated polydimethylsiloxane, phenylaminopropyl diethoxy terminated polymethylpropylsiloxane, N-phenylaminopropyl dimethoxy terminated polymethylphenylsiloxane, N-methyl-aminopropyl dimethyl terminated polydimethylsiloxane, and aminopropyl dimethyl terminated polymethylphenylsiloxane, and combinations thereof.

The silane component C used herein includes silanes having two or more, preferably 2-4, amino, imino, hydrazino, and/or alkylhydrazino and from 0 to 3 alkoxy groups. The silane component C is preferably a monomer embraced by the structure of the following formula, or mixture thereof:

HN(Rₑ)R_{d}NH—R_{c}—Si(Rₐ)_{y}(OR_{b})_{3-y}

where Rₐ, R_{b}, R_{c}, R_{d}, Rₑ, and y are defined as above.

The silane component C is preferably selected from aminoethyl aminopropyl trimethoxy silane, aminoethyl aminopropyl triethoxy silane, aminoethyl aminopropylmethyl dimethoxy silane, aminoethyl aminopropylmethyl diethoxy silane, aminoethyl aminomethyl triethoxy silane, aminoethyl aminomethyl methyl diethoxy silane, hexamethylenediamino methyl trimethoxy silane, γ-divinyltriaminopropyl triethoxy silane, γ-divinyltriaminopropyl methyl diethoxy silane, γ-divinyltriaminomethyl triethoxy silane, γ-divinyltriaminomethyl methyl diethoxy silane, hydrazinopropyl triethoxy silane, hydrazinopropyl methyl diethoxy silane, hydrazinomethyl triethoxy silane, hydrazinomethyl trimethoxy silane, hydrazinomethyl methyl dimethoxy silane, hydrazinomethyl methyl diethoxy silane, and mixtures thereof in any ratio.

In the present invention, component C serves as a chain extender for prepolymer obtained from reacting components A and S, and results in a base polymer having a relatively higher molecular weight. A crosslinked network structure of intra- and inter-molecules is formed in the base polymer through inter-crosslinking of pendant siloxane groups on side chains of its molecular chains, thereby obtaining the elastomer of interest in the present invention.

The amount of the component C, based on the total weight of reactive components for preparing the base polymer, is 0.01 to 60% by weight, preferably 0.1 to 35% by weight, more preferably 0.2 to 30% by weight.

Preferably, the amount ratio of the components A, B and C satisfies the following condition: the molar ratio of isocyanato radical to all radicals reactive with polyisocyanate, including amino, imino, hydrazino, and alkylhydrazino, is 0.5-3:1, more preferably 0.6-2:1, most preferably 0.8-1.2:1.

The auxiliary chain extender used herein preferably has a general formula: NH(Rₑ)R_{d}NH(Rₑ), where R_{d} and Rₑ are defined as above, and the two Rₑ are either the same or different. Its amount, based on the total weight of reactive components for preparing the base polymer, is from 0.01 to 10% by weight, preferably from 0.1 to 3% by weight. By virtue of adding the auxiliary chain extender into the base polymer, the properties of the base polymer and the elastomer prepared therefrom can be further improved.

The present end-capping agent selected from monoamino silanes and monoamines is used in an amount, based on the total weight of reactive components for preparing the base polymer, of from 0.01 to 30% by weight. The monoamine monomer has a general formula: HN(Rₑ)R_{f}, and the monoimino silane end-capping agent has a general formula: HN(Rₑ)—R_{g}—Si(Rₐ)_{y}(OR_{b})_{3-y}, where Rₑ, Rₐ, R_{b}, R_{f}, R_{g} and y are defined as above. When the end-capping agent is a monoamino silane, it is used in an amount, based on silane component C, of from 1 to 50% by weight.

Regarding the method for preparing said self-crosslinking organosilicon-polyurea base polymer, a first embodiment comprises the steps of:

(1) reacting a polyisocyanate component A having two or more isocyanate functional groups with a polysiloxane component B having two amino or imino groups, to obtain an isocyanato-capped prepolymer; and

(2) further reacting after adding a silane component C having two or more amino, imino, hydrazino, and/or alkylhydrazino and from 0 to 3 alkoxy groups, to obtain an organosilicon-polyurea base polymer.

Preferably, the prepolymer obtained by reacting components A and B has a weight average molecular weight of from 2.9×10² to 2.0×10⁵.

Regarding the method for preparing said self-crosslinking organosilicon-polyurea base polymer, a second embodiment comprises the steps of:

(1) reacting a polyisocyanate component A having two or more isocyanate functional groups with a silane component C having two or more amino, imino, hydrazino, and/or alkylhydrazino and from 0 to 3 alkoxy groups, to obtain an isocyanato amino silane coupling agent; and

(2) further reacting after adding a polysiloxane component B having two amino or imino groups, to obtain an organosilicon-polyurea base polymer.

Regarding the method for preparing said self-crosslinking organosilicon-polyurea base polymer, a third embodiment comprises the steps of:

(1) forming a mixture of a silane component C having two or more amino, imino, hydrazino, and/or alkylhydrazino and from 0 to 3 alkoxy groups, with a polysiloxane component B having two amino or imino groups; and

(2) adding a polyisocyanate component A having two or more isocyanate functional groups to the above mixture, and then allowing the components A, B and C to react simultaneously, thereby obtaining an organosilicon-polyurea base polymer.

With respect to the present preparation methods, the preferred embodiments include: (I) multiple-step reaction comprising reacting components A and B to obtain a prepolymer, and further reacting after adding component C; and (II) one-step reaction including pre-mixing components B and C, and then reacting together after adding component A.

In the present preparation methods of the base polymer, the entire polymerization reactions may be carried out in air or under the protection of an inert gas, said inert gas including nitrogen, argon and helium, preferably nitrogen or argon. Preferably, the typical reaction steps (1) and (2) in the above embodiments are under the protection of an inert gas.

In the present preparation methods of the base polymer, each step of the polymerization reactions may be carried out in the presence of a solvent; and the polymerization may be solution polymerization.

In the present preparation methods of the base polymer, each step of the polymerization reactions among components A, B and C may also be bulk polymerizations in the absence of a solvent.

In the solution polymerization, suitable organic solvents include, but are not limited to: tetrahydrofuran (THF), toluene, dimethyl formamide (DMF), dimethyl acetamide (DMAc), methylpyrrolidone, xylene or mixtures thereof preferably THF, DMF and DMAc, most preferably a mixed solvent of THF-toluene in a volume ratio of 1:1. In the solution polymerization, the reactive components for forming the base polymer and the solution are in a weight ratio (i.e., solid content of the solution) of 1 to 80% by weight, preferably 5 to 70% by weight, most preferably 10 to 50% by weight.

In the present preparation method of the self-crosslinking organosilicon-polyurea base polymer, each step of the polymerization reactions may be carried out at room temperature or lower temperature, or under heating condition to speed up the reaction course. In the solution polymerization, the reaction temperature is preferably from 0 to 150° C. and must be kept at below boiling point of the solvent used, more preferably 10 to 80° C., even more preferably 30 to 70° C. In the bulk polymerization, the reaction temperature is preferably 0 to 250° C., more preferably 25 to 190° C., even more preferably 80 to 160° C.

In the solution polymerization, the reactants may be added in batch or in droplet. The reaction is generally finished within 1 to 24 hr in total, wherein step (1) is generally finished within 0.5 to 10 hr; and step (2) is generally finished within 0.5 to 14 hr, if necessary, the concrete reaction time may be determined via detecting the desired small molecule (the component A and the component C of the present invention) content and extent of reaction by gas chromatography and then solvent and low-boiler are removed by natural volatilization at room temperature drying condition, or the low-boiler is extracted under dry and vacuum condition at 60° C. for 5-6 hr, thereby obtaining a dry base prepolymer.

In the bulk polymerization, the reaction time is generally 0.02-10 hr in total, wherein step (1) is generally finished within 0.01 to 4 hr; and step (2) is generally finished within 0.01 to 6 hr, if necessary, the concrete reaction time may be determined via detecting the desired small molecular (the component A and the component C of the present invention) content and extent of reaction by gas chromatography, thereby obtaining a dry base prepolymer.

In the present preparation method of the self-crosslinking organosilicon-polyurea base polymer, each step of polymerization reactions may be carried out at normal pressure or lower, or under pressurized protection of an inert gas. In solution polymerization, the reaction pressure is preferably 0.1 to 5 atm (absolute pressure, the same below), more preferably 0.5 to 3 atm, even more preferably 0.9 to 2 atm. In bulk polymerization, the reaction pressure is 0.01 to 10 atm, preferably 0.1 to 5 atm, more preferably 0.9 to 3 atm.

Each step of bulk polymerization reactions may be carried out in a mixing extruder or extruding gun. The mixing extruder used herein includes single-screw, twin-screw or multi-screw extruder as commonly used for processing macromolecules, and high-speed mixer (e.g., planet-type mixer (Hauschild Speed Mixer), manufactured by Flack Tek Co. (Landrum, S.C. 29356, U.S.A.)). The suitable extruding gun used herein includes those commonly used in the field of sealants, such as extruding guns (e.g., Loctite® Dual Cartridge Manual Applicators, Models 983438 and 985246; Loctite® Universal Metal Dispenser, Model 985245; or High precision Loctite® Meter Mix Dispense Systems), manufactured by Henkel Corporation (Rocky Hill, Conn. 06067, U.S.A.).

The present organosilicon-polyurea base polymer can self-crosslink and cure in humid environment at room temperature, or under heating condition (a heating temperature 25-250° C.). Since siloxane functional groups inside the organosilicon-polyurea elastomer can react and then crosslink in the presence of steam in air, a suitable amount of water may also be added during the course of preparing the elastomer for promoting crosslinking, and increasing crosslinking speed and crosslinking extent. The amount of the added water is 0.01-1% by weight of the base polymer.

The crosslinking reaction of the present self-crosslinking organosilicon-polyurea base polymer can also be carried out in the presence of a catalyst for accelerating the crosslinking reaction. The catalyst is selected from those commonly used for preparation of polyurethane and polyurea, for instance, conventional catalysts used in hydrolysis-condensation reaction of organic alkoxy silyl radicals or in condensation reaction of organic silanol, including various acids, bases, salts, metal oxides and mixtures thereof. The acid catalyst is selected from, but not is limited to, sulfuric acid, hydrochloric acid, acetic acid, oxalic acid, trichloroacetic acid, methylbenzenesulfonic acid and mixtures thereof. The base catalyst is selected from, but is not limited to, triethylamine, triethylenediamine, tertiary amines, silylated amines and mixtures thereof. The salt catalyst is selected from stannous caprylate, dibutyl dilaurate, alkyl tin, alkyl aluminum, alkoxides, siloxides, and mixtures thereof. The metal oxide catalyst is selected from, but is not limited to, vanadic oxide, tetraisopropyl zirconium oxide and mixtures thereof. Preferred catalysts are organic tin such as stannous caprylate and dibutyl dilaurate; and tertiary amine such as triothylamine and triethylenediamine, and mixtures thereof. The catalyst is more preferably stannous caprylate, dibutyl dilaurate, triethylenediamine, and mixtures thereof. The catalyst can also be added when preparing the base polymer.

During the course of crosslinking the present self-crosslinking organosilicon-polyurea base polymer, a silane crosslinking agent having two or more preferably 2 to 4, alkoxy groups may be added for further enhancing the crosslinking property, which includes, but is not limited to, one or more selected from ethyl orthosilicate, methyltrimethoxy silane, aminoethyl aminopropyl methyl diethoxy silane, and N-aminomethyl trimethoxy silane. The amount of the silane crosslinking agent is, based on the total weight of the base polymer, from 0.01 to 30% by weight, preferably from 0.1 to 20% by weight. The silane crosslinking agent can also be added when preparing the base polymer.

To the elastomer obtained by crosslinking the present self-crosslinking organosilicon-polyurea base polymer, a filler, such as one or more selected from silica, titania, iron oxide, calcium carbonate and carbon black, may be added for further enhancing the property of the elastomer. The amount of the filler is, based on the total weight of the elastomer, from 0.1 to 60% by weight, preferably 1 to 40% by weight.

The present invention is characterized by introducing the above silane component C, which not only serves as a chain extender to increase molecular weight of the base polymer, but also endows, owing to its crosslinking groups, the base polymer with the specialty of being curable at room temperature. Moreover, by adjusting the ratio of component C, the molecular weight and degree of crosslinking of the final elastomeric polymer material can be directly controlled, so that the preparation and property adjustment of the polymer material become simple and direct.

The present preparation method of the self-crosslinking organosilicon-polyurea base polymer is not restricted by the charging order of components, and the three components may even react simultaneously. The preparation method is simple and easily-operated.

The present preparation method of the self-crosslinking organosilicon-polyurea base polymer may include direct bulk polymerization reactions in the absence of a solvent, thereby eliminating the necessity of utilizing and recovering solvent, which is in favor of environmental protection.

By changing the ratios of component C, said end-capping agent and said auxiliary chain extender, the elastomer obtained by crosslinking the present self-crosslinking organosilicon-polyurea base polymer may have an elongation varying in the range of 10 to 1500%. The crosslinked material has excellent high- and low-temperature resistance, which keeps good elasticity generally at a temperature range from −40 to 250° C., and has a thermal decomposition temperature up to 200° C. The crosslinked elastomer is hardly dissolved in routine organic solvents, and the swelling ratio thereof varies from 50 to 300%, depending on different crosslinking density.

The present elastomeric material can be widely used as sealants, adhesives, gaskets, buffer layers and coatings, in particular as sealants in automobile industry, for instance, as sealants of oil pipes and hoods in automobile assembly.

The present self-crosslinking organosilicon-polyurea base polymer can be in the form of a solution sol in their routine solvents. The solution sol can then be applied, once or more times, to a substrate to be sealed by means of seal-coating, casting or kiss-coating. The dry film obtained has a thickness of from 0.01 to 10 mm. The suitable substrate includes such as metal, plastic, rubber, wood and glass.

Unless identified otherwise, the percentages and ratios used herein are all on the basis of weight; and the amounts of various components are all on the basis of the total weight of reactive components for preparing the base polymer.

All the publications mentioned are incorporated herein for reference in their entirety for all purposes.

### EXAMPLES

The following examples further demonstrate the preferred embodiments of the present inventions. All the examples are merely illustrative, not interpreted as limiting to the present inventions.

Unless identified otherwise, each steps involved in the following examples are all conducted under atmospheric pressure, ambient temperature, and the relative humidity of 50%.

Unless identified otherwise, in the following examples, polysiloxanes used are purchased from Gelest Co., 11 East Steel Rd., Morrisville, Pa. 19067, U.S.A., polyisocyanates used are purchased from Aldrich Chemical Co., P.O. Box 2060, Milwaukee, Wis. 53201, U.S.A., and all the remaining reagents like organic solvents and catalysts used herein are purchased from Shanghai Chemicals Co., Shanghai, China.

The methods for determining relevant data in examples of the present invention are as follows.

The thermogravimetric analysis of sample is determined by using a TGA-6 device, manufactured by PerkinElmer Co., (45 William Street, Wellesley, Mass. 02481-4078, USA) U.S.A., with a temperature range of from room temperature to 1000° C., a sensitivity of 0.1 μg and a heating rate of 0.1-200° C./min.

The stress-strain property of sample is determined by using WO-I model electronic universal test machine (Instron Corporation, 825 University Avenue, Norwood, Mass. 02062-2643, USA), according to US standard ASTM-D412.

The swelling ratio of sample is determined by the steps as follows: about 1 g of sample dry film as exactly weighted is placed in a closed vessel, and dipped in a toluene solvent at 20° C. for 24 hr, and then immediately weighted after taking it out. The increased mass of sample is obtained by deducting the mass of initial dry film from the mass of sample having absorbed toluene, and then the swelling ratio of sample is obtained from dividing the mass of initial sample by the increased mass.

The molecular weight and its distribution of the organosilicon-polyurea base polymer are determined by GPC-244 model gel permeation chromatograph with a separator column PLGEL10 MIX-B (Waters Corporation, 34 Maple Street, Milford, Mass., 01757 USA), and with THF as mobile phase.

Unless identified otherwise, all the determinations are performed under atmospheric pressure, ambient temperature, and the relative humidity of 50%.

### Example 1

In a vessel with agitator, 200 g aminopropyl dimethyl terminated polydimethylsiloxane (M_{w}=1000; 0.4 moles amino groups, Gelest Co.) was dissolved with 1 L solvent (toluene:THF=1:1, volume ratio), to which 66.6 g IPDI (0.6 moles NCO) was added before allowing the system to react at 40° C. for 2 hr. After adding 26.4 g aminoethyl aminopropyl triethoxy silane (0.2 moles amino groups, TM-552, Wuhan Tianmu Science and Technology Co., 96# South Road of Zhuodaoquan, Hongshan District, Wuhan City, China,), the system continuously reacted at 40° C. for 4 hr. The reaction was carried out under N₂ protection at 1.01 atm. A solution sol of organosilicon-polyurea base polymer having a molar ratio of components A:B:C=3:2:1 was finally prepared. The solution sol was poured to form a film, which was cured and crosslinked at room temperature to obtain an elastomertic material. The base polymer, prior to crosslinking, had a weight average molecular weight of 1×10⁵. The elastomeric material had an elongation at break of 200%, and a Young modulus of 44.3 Mpa, which began to thermally decompose at 220° C., kept elastic at a temperature range of 40 to 200° C., and had a swelling ratio of 250% in toluene.

### Example 2

In a dual-cartridge extruding gun (Loctite® Dual Cartridge Manual Applicators, model 983438, with a volume ratio of A:B=10:1, manufactured by Henkel Co.), 300.0 g aminopropyl dimethyl terminated polymethylphenylsiloxane (M_{w}=3000; 0.2 mol amino groups, made by referring to James E. McGrath, Debra L. Dunson, Sue J. Mechaml, James L. Hedrick, Advances in Polymer Science, Vol. 140, 1999, 62-99) was added to A; and 33.6 g cyclohexylene diisocyanate (0.4 moles NCO,) and 19.6 g aminoethyl aminopropyl methyldimethoxy silane (TM-602, 0.2 mol amino groups, Wuhan Tianmu Science and Technology Co.) as well as 0.005 g stannous caprylate (Shanghai Qidi Chemical Industry Co., Ltd., 2299# North Road of Zhongshan, Shanghai City, China) were added to B. The forehead mixer of the extruding gun is φ 8 mm static mix nozzles Part No. 983443. By virtue of extrusion at room temperature, an elastomeric material from organosilicon-polyurea base polymer having a molar ratio of components A:B:C=2:1:1 was obtained over 15 seconds. The elastomeric material had an elongation at break of 320%, and a Young modulus of 14.8 Mpa, which began to thermally decompose at 250° C., kept elastic at a temperature range of −50 to 250° C., and had a swelling ratio of 107% in toluene.

### Example 3

In a vessel with agitator, 475 g aminopropyl dimethyl terminated polydimethylsiloxane (M_{w}=5000; 0.19 moles amino groups, made by referring to the same document as given in Example 2) was dissolved with 1 L solvent (DMF:THF=1:2, volume ratio), to which 25 g MDI (0.20 moles NCO) was added before allowing the system to react at 50° C. for 1 hr. After adding 1.11 g aminoethyl aminopropyl methyldimethoxy silane (0.01 moles amino groups, primary amino groups plus secondary amino groups, TM551, Wuhan Tianmu Science and Technology Co.), the system continuously reacted at 50° C. for 4 hr. The reaction was carried out under N₂ protection at 1.05 atm. A solution sol of organosilicon-polyurea base polymer having a molar ratio of components A:B:C=20:19.1 was finally prepared. The solution sol was poured to form a film, which was cured and crosslinked at room temperature to obtain an elastomertic material. The base polymer, prior to crosslinking, had a weight average molecular weight of 8×10⁴. The elastomeric material had an elongation at break of 500%, and a Young modulus of 4.1 Mpa, which began to thermally decompose at 200° C., kept elastic at a temperature range of −50 to 200° C., and had a swelling ratio of 90% in toluene.

### Example 4

In a vessel with agitator, 500 g N-methyl-aminopropyl dimethyl terminated polydimethylsiloxane (M_{w}=1000; 1 moles amino groups, made by referring to the same document as given in Example 2) was dissolved with 1 L solvent (toluene:THF=1:1, volume ratio), to which 258 g cyclohexylene diisocyanate (3.11 mol NCO) together with 166 g hydrazinomethyl trimethoxy silane (2 moles amino groups, primary amino groups plus secondary amino groups, made by referring to Study on Novel α-silane Coupling Agent, Shi Baochuan, Article Collection of 12^{th} China Silicone conference, 289-295, Nanjing Normal Universiy, Nanjing 210097, China) were added before allowing the system to react at 50° C. for 5 hr. The reaction was carried out under argon protection at 1.0 atm. A solution sol of organosilicon-polyurea base polymer having a molar ratio of components A:B:C=31:10:20 was finally prepared. The solution sol was poured to form a film, which was cured and crosslinked at room temperature to obtain an elastomertic material. The elastomeric material had an elongation at break of 100%, and a Young modulus of 9.2 Mpa.

1-69. (canceled)

70. An organosilicon-polyurea base polymer capable of self-crosslinking under humid condition, comprising the following formula: 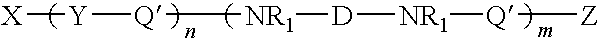
where:
m and n are respectively an integer from 1 to 750;
Q′=CO—NR-Q-NR—CO, where: Q is a divalent moiety selected from C₆-C₂₀ arylene radical, C₆-C₂₀ aralkylene radical, C₁-C₂₀ alkylene radical, C₆-C₂₀ cycloalkylene, and combinations thereof; and R is hydrogen or C₁-C₁₂ alkyl radical;
R₁ is a member selected from the group consisting of hydrogen, C₁-C₁₂ alkyl radical, C₆-C₂₀ cycloalkyl radical, C₆-C₂₀ aryl radical, C₆-C₂₀ aralkyl radical, C₆-C₂₀ alkaryl radical and combinations thereof;
Y is embraced by the structure: 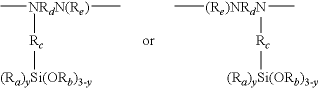
where: Rₐ and R_{b} are respectively selected from the group consisting of C₁-C₁₆ alkyl radical, C₆-C₂₀ aryl radical, C₆-C₂₀ aralkyl radical, C₆-C₂₀ alkaryl radical, and combinations thereof; y=0 to 3; R₁ is a divalent moiety selected from the group consisting of C₁-C₁₂ alkylene radical, C₁-C₁₂ imino-containing alkylene radical, C₆-C₂₀ imino-containing arylene radical, C₆-C₂₀ aralkylene radical, C₆-C₂₀ alkarylene radical, and combinations thereof;
R_{d} is a direct bond, or a divalent moiety selected from C₁-C₁₂ alkylene radical, C₁-C₁₂ imino-containing alkylene radical, C₆-C₂₀ imino-containing arylene radical, C₆-C₂₀ aralkylene radical, C₆-C₂₀ alkarylene radical, and combinations thereof; and
Rₑ is selected from hydrogen, C₁-C₁₂ alkyl radical, C₁-C₁₂ imino-containing alkyl radical, C₆-C₂₀ imino-containing aryl radical, C₆-C₂₀ aralkyl radical, C₆-C₂₀ alkaryl radical, and combinations thereof;
D is embraced by the structure: 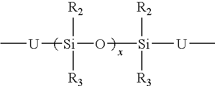
wherein: x ranges from 1 to 2000;
U is a divalent moiety selected from the group consisting of C₁-C₁₂ alkylene radical, C₁-C₁₂ iminoalkyl or polyiminoalkyl radical, C₆-C₂₀ cycloalkylene radical, C₆-C₂₀ iminocycloalkyl radical, C₆-C₂₀ arylene or aryleneamino radical, C₆-C₂₀ aralkylene radical, C₆-C₂₀ alkarylene or iminoaryl radical, and combinations thereof; and
R₂ and R₃ are respectively selected from the group consisting of C₁-C₁₂ alkyl radical, C₆-C₂₀ cycloalkyl radical, C₆-C₂₀ aryl radical, C₆-C₂₀ aralkyl radical, C₆-C₁₆ alkaryl radical and combinations thereof;
X is selected from the group consisting of H, OCN-Q-NRCO—, HNR₁-D-NR₁-Q′-, and E-Q′-, where R, D, R₁, Q and Q′ are defined as above;
Z is selected from the group consisting of —Y—X, —NR₁-D-NR₁—X, and E, where Y, X, R₁ and D are defined as above;
where is a residue of monoamine monomer or a residue of monoimino silane end-capping agent, with the residue of monoamine monomer having a general formula: —N(Rₑ)R_{f}, and the residue of monoimino silane end-capping agent having a general formula: —N(Rₑ)—R_{g}—Si(Rₐ)_{y}(OR_{b})_{3-y}, where Rₑ, Rₐ, R_{b} and y are defined as above; R_{f} is selected from the group consisting of C₁-C₁₂ alkyl radical, C₆-C₂₀ cycloalkyl radical, C₆-C₂₀ aryl radical, C₆-C₂₀ aralkyl radical, C₆-C₂₀ alkaryl radical, and combinations thereof; R₉ is a divalent moiety selected from the group consisting of C₁-C₁₂ alkylene radical, C₆-C₂₀ cycloalkylene radical, C₆-20 arylene radical, C₆-C₂₀ aralkylene radical, C₆-C₂₀ alkarylene radical, and combinations thereof.

71. The base polymer as claimed in claim 70, wherein Q is selected from the group consisting of tolylene radical, 4,4′-diphenylenemethyl radical, 3,3′-dimethyl-4,4′-biphenylene radical, tetramethyl-m-dimethylenephenyl radical, phenylene radical, naphthylene radical, 4,41-dicyclohexylenemethyl radical, 1,6-hexylene radical, 1,4-cyclohexylene radical, methylcyclohexylene radical and 3,5,5-trimethyl-3-methylenecyclohexyl radical.

72. The base polymer as claimed in claim 70, which has a weight average molecular weight of from 3×10² to 2×10⁵, and a molecular weight distribution index of 1 to 3.

73. The base polymer as claimed in claim 70, wherein reactive components for preparing the base polymer comprise:
(A) a polyisocyanate having two or more isocyanate functional groups;
(B) a polysiloxane having two amino or imino groups; and
(C) a silane having two or more amino, imino, hydrazino, and/or alkylhydrazino and from 0 to 3 alkoxy groups.

74. The base polymer as claimed in claim 73, wherein the reactive components further comprise an end-capping agent selected from the group consisting of monoamino silanes and monoamines, and/or an auxiliary chain extender selected from diamines or polyamino compounds.

75. The base polymer as claimed in claim 73, wherein the polysiloxane component B has the following formula: 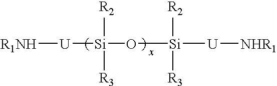
wherein:
x ranges from 1 to 2000;
U is a divalent moiety selected from the group consisting of C₁-C₁₂ alkylene radical, C₁-C₁₂ iminoalkyl or polyiminoalkyl radical, C₆-C₂₀ cycloalkylene radical, C₆-C₂₀ iminocycloalkyl radical, C₆-C₂₀ arylene or aryleneamino radical, C₆-C₂₀ aralkylene radical, C₆-C₂₀ alkarylene or iminoaryl radical, and combinations thereof;
R₁ is selected from the group consisting of hydrogen, C₁-C₁₂ alkyl radical, C₆-C₂₀ cycloalkyl radical, C₆-C₂₀ aryl radical, C₆-C₂₀ aralkyl radical, C₆-C₂₀ alkaryl radical and combinations thereof;
R₂ and R₃ are respectively selected from C₁-C₁₂ alkyl radical, C₆-C₂₀ cycloalkyl radical, C₆-C₂₀ aryl radical, C₆-C₂₀ aralkyl radical, C₆-C₂₀ alkaryl radical, and combinations thereof.

76. The base polymer as claimed in claim 75, wherein the polysiloxane component B has a weight average molecular weight of from 1.92×10² to 1.0×10⁵, and a molecular weight distribution index of 1 to 3.

77. The base polymer as claimed in claim 73, wherein the silane component C is a monomer embraced by the structure of the following formula, or mixture thereof:
HN(Rₑ)R_{d}NH—R_{c}—Si(Rₐ)_{y}(OR_{b})_{3-y}
wherein:
Rₐ and R_{b} are respectively selected from the group consisting of C₁-C₁₆ alkyl radical, C₆-C₂₀ aryl radical, C₆-C₂₀ aralkyl radical, C₆-C₂₀ alkaryl radical, and combinations thereof;
R_{c} is a divalent moiety selected from the group consisting of C₁-C₁₂ alkylene radical, C₁-C₁₂ imino-containing alkylene radical, C₆-C₂₀ imino-containing arylene radical, C₆-C₂₀ aralkylene radical, C₆-C₂₀ alkarylene radical, and combinations thereof;
R_{d} is a direct bond, or a divalent moiety selected from alkylene radical, C₁-C₁₂ imino-containing alkylene radical, imino-containing arylene radical, C₆-C₂₀ aralkylene radical, C₆-C₂₀ alkarylene radical, and combinations thereof; and
Rₑ is selected from hydrogen, C₁-C₁₂ alkyl radical, C₁-C₁₂ imino-containing alkyl radical, C₆-C₂₀ imino-containing aryl radical, C₆-C₂₀ aralkyl radical, C₆-C₂₀ alkaryl radical, and combinations thereof; and
y=0 to 3.

78. The base polymer as claimed in claim 74, wherein the auxiliary chain extender has a general formula: NH(Rₑ)R_{d}NH(Rₑ), wherein:
R_{d} is a direct bond, or a divalent moiety selected from alkylene radical, C₁-C₁₂ imino-containing alkylene radical, imino-containing arylene radical, C₆-C₂₀ aralkylene radical, C₆-C₂₀ alkarylene radical, and combinations thereof; and
Rₑ is selected from hydrogen, C₁-C₁₂ alkyl radical, C₁-C₁₂ imino-containing alkyl radical, C₆-C₂₀ imino-containing aryl radical, C₆-C₂₀ aralkyl radical, C₆-C₂₀ alkaryl radical, and combinations thereof;
wherein optionally the amount of the auxiliary chain extender, based on the total weight of reactive components for preparing the base polymer, is from 0.01 to 10% by weight.

79. The base polymer as claimed in claim 73, wherein the amount of component A, based on the total weight of reactive components for preparing the base polymer, is from 0.1 to 60% by weight,
wherein the amount of component B, based on the total weight of reactive components for preparing the base polymer, is 30 to 99.9% by weight, and
wherein the amount of component C, based on the total weight of reactive components for preparing the base polymer, is from 0.01 to 60% by weight.

80. The base polymer as claimed in claim 73, wherein the amount ratio of components A, B and C satisfies the following condition: the molar ratio of isocyanato radical to the sum of amino, imino, hydrazino, and alkylhydrazino which are reactive with polyisocyanate is 0.5-3:1.

81. The base polymer as claimed in claim 74, wherein the amount of the end-capping agent, based on the total weight of reactive components for preparing the base polymer, is from 0.01 to 30% by weight, and
wherein the end-capping agent is a monoamino silane, which is used in an amount, based on silane component C, of from 1 to 50% by weight.

82. The base polymer as claimed in claim 73, wherein said polyisocyanate component A has two to four isocyanate functional groups; and said silane component C has 2 to 4 amino, imino, hydrazino, and alkylhydrazino groups and from 0 to 3 alkoxy groups.

83. The base polymer as claimed in claim 70, in the form of sol with organic solvent.

84. An organosilicon-polyurea elastomer obtained by crosslinking the base polymer as claimed in claim 70.

85. The elastomer as claimed in claim 84, wherein the crosslinking is carried out under environmental humid condition and wherein the crosslinking is promoted by adding water in an amount of 0.01 to 1% by weight of the base polymer.

86. The elastomer as claimed in claim 84, wherein the crosslinking is carried out in the presence of a silane crosslinking agent having two or more alkoxy groups, the amount of said silane crosslinking agent being, based on the total weight of the base polymer, from 0.01 to 30% by weight, wherein optionally the silane crosslinking agent is selected from ethyl orthosilicate, methyltrimethoxy silane, aminoethyl aminopropyl methyl diethoxy silane, N-anilinomethyl trimethoxy silane, and mixtures thereof.

87. The elastomer as claimed in claim 84, wherein the crosslinking is carried out in the presence of a catalytically effective amount of a catalyst, wherein optionally the catalyst is selected from sulfuric acid, hydrochloric acid, acetic acid, oxalic acid, trichloroacetic acid, methylbenzenesulfonic acid, triethylamine, triethylenediamine, tertiary amines, silylated amines, stannous caprylate, dibutyl dilaurate, alkyl tin, alkyl aluminum, alkoxides, siloxides, vanadic oxide, tetraisopropyl zirconium oxide and mixtures thereof.

88. The elastomer as claimed in claim 84, wherein the crosslinking is carried out at room temperature or wherein the crosslinking is carried out under heating condition with the heating temperature being from 25 to 250° C.

89. The elastomer as claimed in claim 84, further comprises a solid filler selected from silica, titania, iron oxide, calcium carbonate, carbon black and mixtures thereof in any ratio, wherein optionally the amount of the filler is, based on the total weight of the elastomer, from 0.1 to 60% by weight.

90. A method for preparing an organosilicon-polyurea base polymer as claimed in claim 70, which comprises the steps of:
(1) reacting a polyisocyanate component A having 2 or more isocyanate functional groups with a polysiloxane component B having two amino or Amino groups, to obtain an isocyanato-capped prepolymer; and
(2) further reacting after adding a silane component C having 2 or more amino, imino, hydrazino, and/or alkylhydrazino and from 0 to 3 alkoxy groups, to obtain the organosilicon-polyurea base polymer.

91. A method for preparing an organosilicon-polyurea base polymer as claimed in claim 70, which comprises the steps of:
(1) reacting a polyisocyanate component A having 2 or more isocyanate functional groups with a silane component C having 2 or more amino, imino, hydrazino, and/or alkylhydrazino and from 0 to 3 alkoxy groups, to obtain an isocyanato-amino silane coupling agent; and
(2) further reacting after adding a polysiloxane component B having two amino or imino groups, to obtain the organosilicon-polyurea base polymer.

92. The method as claimed in claim 91, wherein said polyisocyanate component A has two to four isocyanate functional groups; and/or said silane component C has two to four amino, imino, hydrazino, or alkylhydrazino and from 0 to 3 alkoxy groups.

93. A method for preparing an organosilicon-polyurea base polymer as claimed in claim 70, which comprises the steps of:
(1) forming a mixture of a silane component C having 2 or more amino, imino, hydrazino, and alkylhydrazino and from 0 to 3 alkoxy groups, and a polysiloxane component B having 2 amino or imino groups; and
(2) adding a polyisocyanate component A having 2 or more isocyanate functional groups to the mixture, and then allowing the components A, B and C to simultaneously react, thereby obtaining the organosilicon-polyurea base polymer.

94. The method as claimed in claim 90, wherein the reaction is carried out in solution wherein the reaction is solvent-free bulk reaction.

95. The method as claimed in claim 90, wherein the amount ratio of components A, B and C satisfies the following condition: the molar ratio of isocyanato radical to the sum of all amino, imino, hydrazino, and alkylhydrazino radicals which are reactive with polyisocyanate is 0.5-3:1.

96. The method as claimed in claim 90, wherein an end-capping agent is added in the step (1) or (2), which amount, based on the total weight of reactive components for preparing the base polymer, is from 0.01 to 30% by weight, wherein optionally the end-capping agent is a monoamino silane, which is used in an amount, based on silane component C, of from 1 to 50% by weight.

97. The method as claimed in claim 94, which is characterized in that a solvent used in the solution reaction is selected from tetrahydrofuran, toluene, dimethyl formamide, dimethyl acetamide, or a mixed solvent thereof, wherein optionally the mixed solvent by volume ratio is tetrahydrofuran:toluene=3-0.1:1, or tetrahydrofuran:dimethyl formamide=4-0.2:1, or tetrahydrofuran:dimethyl acetamide=4-0.3:1.

98. The method as claimed in claim 94, wherein the bulk reaction is carried out in a mixing extruder or an extruding gun.

99. The method as claimed in claim 94, wherein the reaction temperature, in the solution polymerization, is from 0 to 150° C. and must be kept below boiling point of the solution or the reaction temperature, in the bulk polymerization, is 0 to 250° C.

100. The method as claimed in claim 94, wherein the reaction pressure, in the solution polymerization, is from 0.1 to 5 atm or the reaction pressure, in the bulk polymerization, is from 0.01 to 10 atm.

101. The method as claimed claim 94, wherein the reaction time, in the solution polymerization, is from 1 to 24 hours, wherein optionally the reaction time, in the steps (1) and (2), are respectively from 0.5 to 10 hours and 0.5 to 14 hours.

102. The method as claimed in claim 94, wherein the reaction time, in the bulk polymerization, is from 0.02 to hours, wherein optionally the reaction time, in the steps (1) and (2), are respectively from 0.01 to 4 hours and 0.01 to 6 hours.

103. The method as claimed in claim 90, wherein the reaction is solvent-free bulk reaction.
